(19) United States
(12) Patent Application Publication
(10) Pub. No.: US 2006/0097668 A1
(43) Pub. Date: May 11, 2006

(54) Deflection coil for cathode ray tube

(76) Inventors: Serge Petit, Bressey (FR); Michel Petit, Biarne (FR)

Correspondence Address: THOMSON LICENSING INC., PATENT OPERATIONS, PO BOX 5312, PRINCETON, NJ, 08543-5312, US

(21) Appl. No.: 11/214,178

(22) Filed: Aug. 29, 2005

(30) Foreign Application Priority Data
Aug. 30, 2004 (EP) 0451929

(51) Int. Cl. G09G 1/04

(52) U.S. Cl. 315/370

(57) ABSTRACT

The invention relates to a multiwinding coil intended to serve as a deflection coil for a cathode ray tube. It is provided that on and/or between the winding wires an element made of polymeric material or a mixture of polymers situated within a delimited area of the coil. This enables “ringing” phenomena to be reduced.

The invention relates to a device for the absorption of electromagnetic resonance phenomena that occur in multiwinding coils and particularly in deflection coils for cathode ray tubes. The invention applies in particular to television tubes.

### BACKGROUND OF THE INVENTION

Electromagnetic oscillation phenomena may occur in television sets and in particular in systems using high frequency line scanning (32 kHz, 48 kHz).

These electromagnetic phenomena result in the appearance of a “curtain” type effect on the television screen: namely, the light level (luminance) presents abnormal variations on the left-hand edge of the screen as illustrated in FIG. 1.

This “curtain effect” is especially visible when a uniform image is displayed in this area of the screen. It can easily be characterized by the variations in luminance that it produces during the display of a uniform range.

This phenomenon is referred to in the literature under the term “ringing”.

The physical origin of the ringing phenomenon resides in the fact that a spurious magnetic field is superimposed over the magnetic deflection field of the deflector and thus modulates the scanning speed. As a result, the phosphorus of the screen is not uniformly scanned provoking variations in luminance on the screen. The characteristic frequencies of this spurious field are between 1 and 6 MHz.

The spurious magnetic field that creates this phenomenon may have several causes.

The documents “Measuring ringing in CRT deflection Yokes” by D. W. Harberts—SID digest 99 page 898 and “Suppression of Common-Mode Ringing in CRT deflection Yokes” by D. W. Harberts—SID digest 00 page 492 explain that there may be two main causes that give rise to two types of ringing:

differential mode ringing which results from an oscillation and which provokes a current circulation between the chassis and the line coils (or the frame coils). It thus results from a coupling between the line scanning circuit and the line coils. A spurious oscillating current circulates in the line coils and, as a result, provokes variations in voltage at the terminals of the line coils.

common mode ringing which results from an oscillation that provokes a current circulation by capacitive coupling between the respective line coils and the frame coils and their power-supply circuit. This current causes the potential of each of the coils to oscillate at a few MHz, but, unlike the previous current, does not cause a difference in potential to appear at the terminals, frame coils or line coil terminals.

Various means exist in the technique to damp these oscillations and are described in the following documents:

“Suppression of Common-Mode Ringing in CRT deflection Yokes” by D. W. Harberts; SID digest 00 page 492.

“Calculating RC snubbers for Yoke damping” by J. Hagerman; Hugues—JVC paper

“Dissipation and ringing of CRT deflection coils” by D. W. Harberts; ISBN.

Damping of the differential mode ringing is performed by introducing, for example, an RC circuit between the two extremities of the line or frame coils.

To resolve the problem of common mode ringing, various solutions are provided such as:

damping by an RC circuit introduced between a midpoint of the coil and one of its extremities.

damping of the common mode current by a choke self-inductance.

damping of the interference field through use of a specific wire (ringing free wire).

However, a third cause of ringing has been identified for which no solution exists. This is an “internal ringing” of the line coils.

This ringing is characterized by an internal oscillation for each line coil. An HF current (of several MHz) oscillates between the inductance of certain turns of the coil and the spurious capacitances which couple these same turns. This oscillation presents the following main characteristics:

the current created does not cause a difference in potential to appear at the terminals of the coil.

this current does hot depend on the presence of frame coils on the deflector.

this current exists even on a single line coil.

the frequency of this current is independent of the line scanning circuit.

The line coil of a cathode ray tube comprises four windings.

Each winding or group of turns possesses its own induction coil and resistor. The sum of these four induction coils represents the total inductance for the line coil and the sum of the four resistors represents the total resistance for the line coil.

FIG. 2 shows a circuit diagram for such a line coil with these induction coils L2, L3, L4, L8 and with these four resistors R10, R13, R14, R15.

The capacitances C5, C6, C7, C9 are shown in parallel with the windings and represent the spurious capacitances which may exist between these different groups of turns.

Such a circuit causes an oscillation frequency to appear, but which is not absorbed. To obtain damping, an additional loss element must be introduced. As a result, the resistors R3, R2, R17, R21 were provided in parallel with the spurious capacitances C5 to C9.

If this circuit which represents a line coil is solicited by a voltage level for which the return to equilibrium of the voltage is considered to be at point Y2, a return to equilibrium curve as shown in FIG. 3 is obtained. If the values of the capacitances C5 to C9 and the resistors R3 to R21 are changed, different curves are obtained that display an damped oscillatory rate, the frequency of which may be adjusted by the value of the spurious capacitance. This oscillatory frequency is typically in the order of 1 to 6 MHz (3.5 MHz for example) and corresponds to the frequency observed on the screen.

The damping is due to the resistive value of the turns.

The existence of a natural frequency internal to the line coil is thus demonstrated and may, subsequent to external excitation, oscillate independently of any power-supply circuit.

This natural frequency generates currents of several MHz in certain groups of turns which in their turn induce the magnetic field that disturbs the scanning speed of the beam.

The “internal ringing” line can thus be an oscillation initiated by an external solicitation (return impulse of the line scanning), which occurs between the inductance of certain turns and the spurious capacitance which exists between them. This oscillation is then completely internal to the coil (the voltage at its terminals is stable).

### SUMMARY OF THE INVENTION

The purpose of the invention is thus to provide a solution to damp these internal oscillations.

The invention thus relates to a multiwinding coil intended to serve as a deflection coil for a cathode ray tube. This coil comprises an element on and/or between the wires of the coil which is made of a polymer material or a mixture of polymers situated within a delimited area of the coil.

Advantageously, the said element is located on at least one face of the coil in the said delimited area.

This area may be located on a section common to the various windings of the said coil.

The said element can also be located on a face of the common section of the coil. This face is opposite the face intended to be in contact with a cathode ray tube.

Alternatively, the material of the said element can cover all or part of the turns or groups of turns of the coil in the said delimited area.

According to one embodiment of the invention, the material of the said element is a polymer material that presents ionic type fillers.

According to another embodiment of the invention, the material of the said element may be constituted by an insulating polymer matrix that contains conductive polymer material fillers. The size of the conductive material fillers will be adapted to the frequency of the oscillations to be absorbed.

The material of the said element may then, for example, comprise an insulating polymer matrix of polyvinyl acetate (PVAc), with the formula: 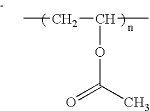
or a P(Vac-co-CROTONIC ACID) compound of the polyvinyl acetate type (beta-methyl acrylic acid) with the formula:

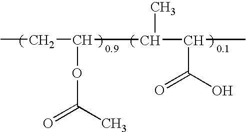

and the conductive material fillers may be a polymer with the formula:

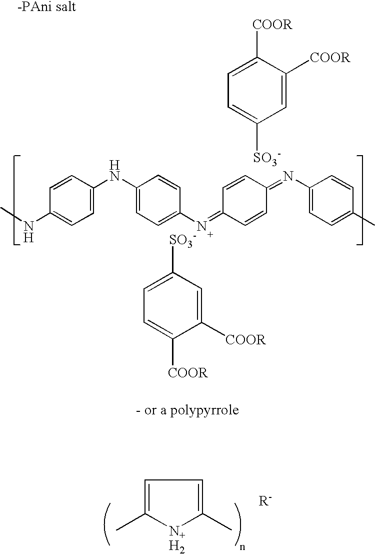

According to a variant embodiment of the invention, the material of the said element is a polymer with the formula:

a poly(ammonium) of formula:

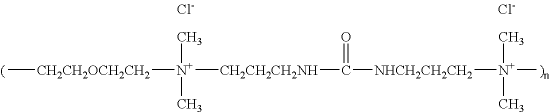

or a poly(ammonium styrene sulfonic acid) of formula:

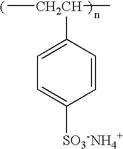

or a poly(styrene sulfonate) of formula:

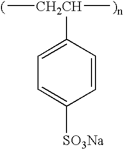

or a saponified acrylic acid of formula: 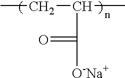
Taking into account the frequency range of the oscillations to be absorbed, the material of the said element may be a polymer of the dielectric polymer family either by ionic polarization relaxation or by interfacial polarization relaxation.

In general, the material of the said element presents the following characteristics if possible:

high dielectric losses in a range of frequencies to be absorbed.

low dielectric losses within a usage frequency range of the coil

good wettability with the external coating of the wires of the coil,

chemical compatibility with the constituents of the wires of the coil,

compatibility with all the environmental conditions to which the wires are subjected.

Advantageously, the frequencies to be absorbed are within the 1 to 6 MHz range and the usage frequency is within the 100 to 300 KHz range.

### BRIEF DESCRIPTION OF THE DRAWINGS

The different objects and characteristics of the invention will be described more clearly in the description hereafter and in the annexed drawings which are constituted by:

FIG. 1, a representation of a screen containing a defect which the invention must rectify,

FIG. 2, an equivalent circuit representing a multiwinding coil to which the invention applies,

FIG. 3, a curve demonstrating the internal oscillation phenomenon of a circuit such as the one in FIG. 2,

FIG. 4, an example of a multiwinding coil to which the invention applies,

FIGS. 5a to 5d, different embodiments of the of the device according to the invention,

FIG. 6, the equivalent circuit of a coil illustrating the principle of the invention,

FIG. 7, an example of an experimental device used to measure the internal oscillations of multiwinding coils,

FIG. 8, detection curves obtained using the experimental device illustrated in FIG. 7.

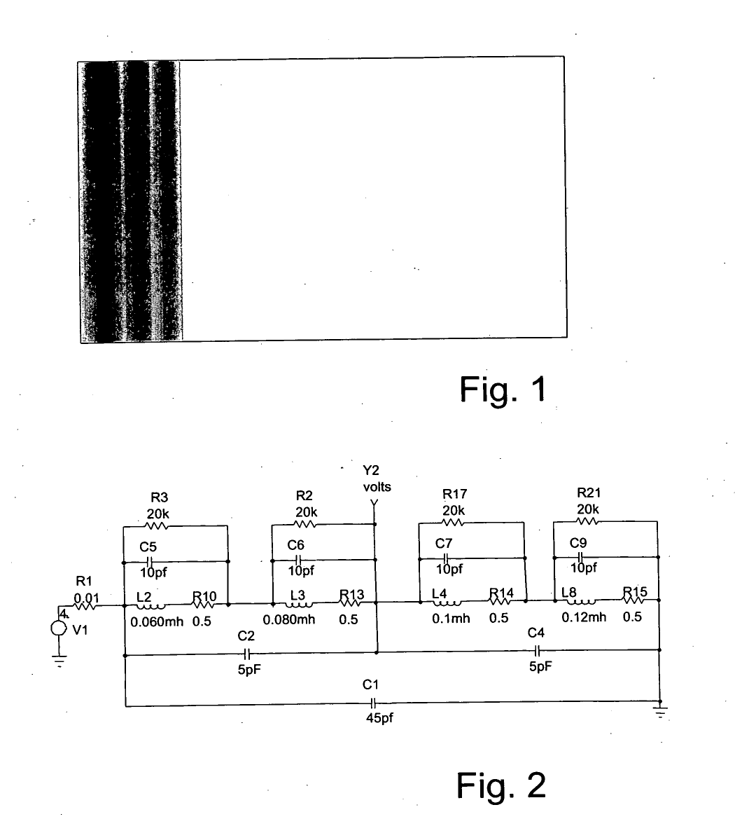

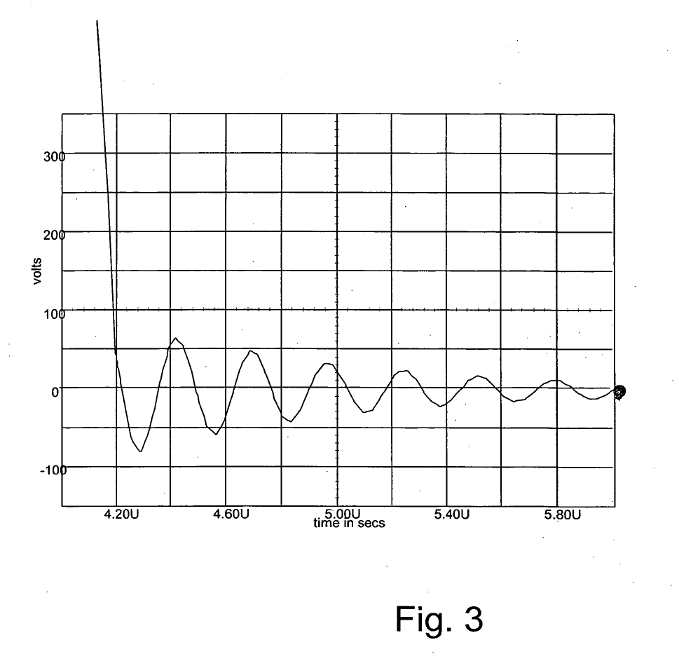

### DETAILED DESCRIPTION

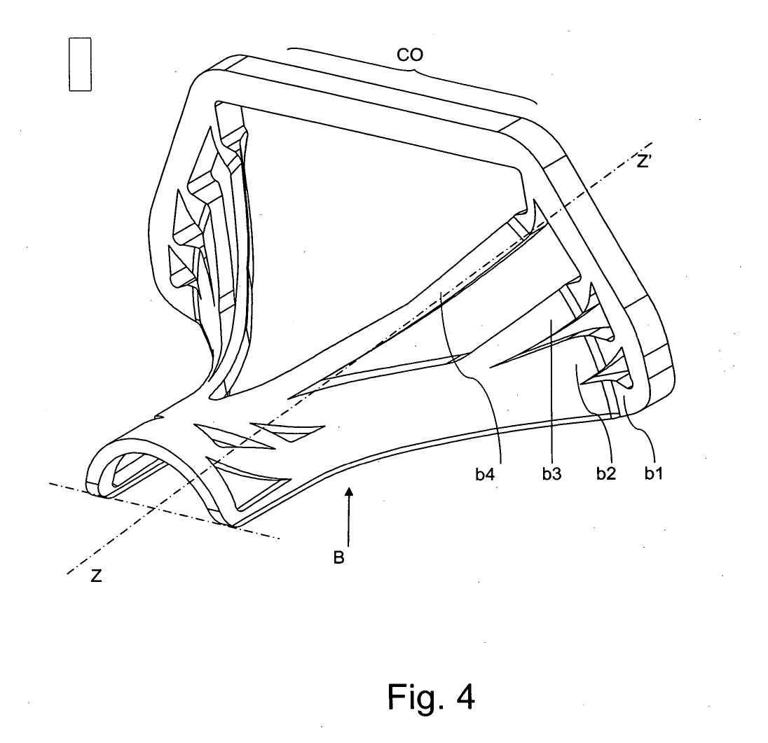

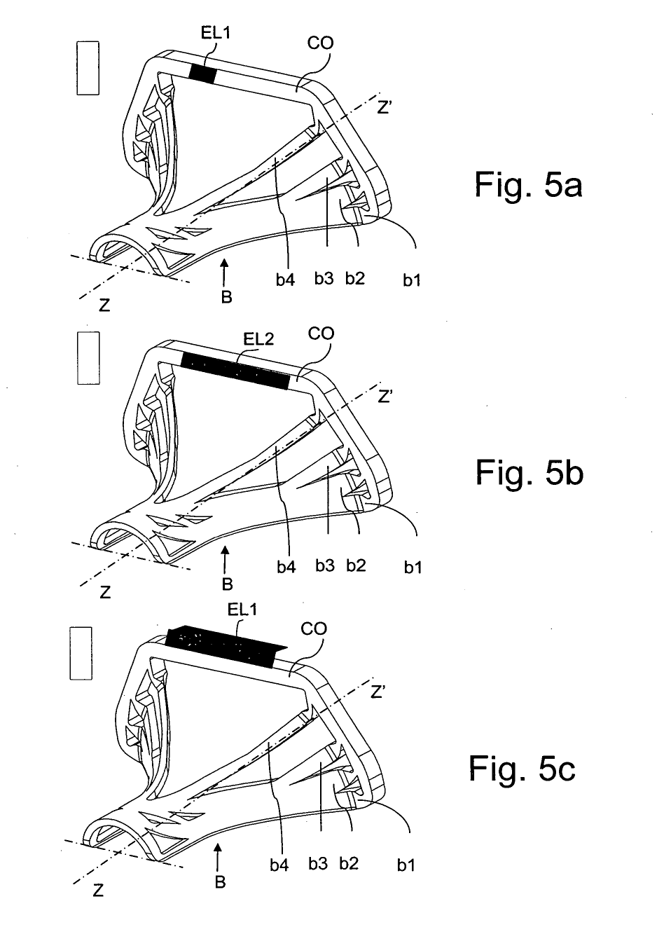

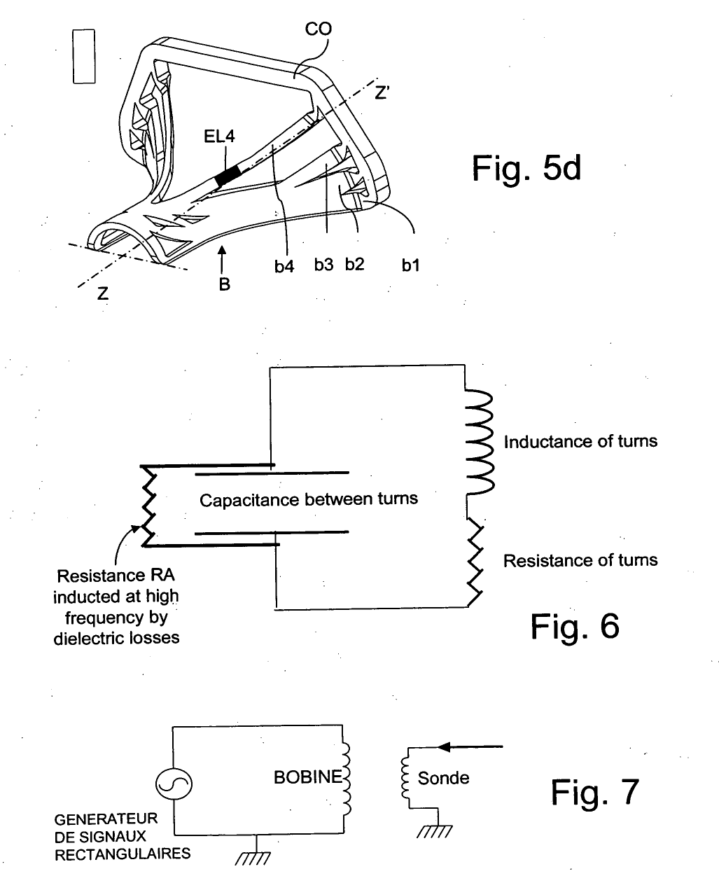

By referring to FIGS. 4 and 5, an embodiment of the invention will thus be described.

FIG. 4 represents an example of a coil that can be used as a line deflection coil in a cathode ray tube.

A coil B as shown in FIG. 4 comprises several windings (or groups of turns), b1, b2, b3 and b4, which pass through a CO common area. Although this is not shown in FIG. 4, it is evident that each coil is constituted by a certain number of turns; FIG. 4 provides a general illustration of the wiring strands of the various windings.

According to the invention, a material presenting the following characteristics will be deposited on (or in) at least one specified and chosen area of at least one winding:

high dielectric losses in the resonance frequency range to be absorbed (1 to 6 MHz in our case),

low dielectric losses in the operating frequency range of the coil (maximum frequency of the line return signal 150 KHz),

good wettability with the external coating of the winding wires,

chemical compatibility with the constituents of the winding wires,

compatibility with all the environmental conditions to which the wires are subjected.

Good wettability and fluidity of the deposited material is desirable to ensure that it adheres effectively to the winding wires but also that the material can be easily inserted between the wires when it is deposited and thus fit between the interspire spurious capacitance to absorb the disturbance field as close to the source as possible.

Chemical compatibility with the winding wires and with the accompanying protective varnish is indispensable to preserve their insulation characteristics.

With regard to compatibility with the environmental conditions, the material deposited must be basically stable at the temperatures of use. Typically, in the case of a cathode ray tube, it is considered that the material must be stable up to a temperature of approximately 150° C.

The said element can be designed to be made of polymeric material or a mixture of polymeric materials.

Taking into account the frequency range of the oscillations to be absorbed, the said element can be designed to present dielectric losses either through ionic polarisation relaxation or through interfacial polarisation relaxation.

In the event of dielectric losses through ionic polarisation, it can also be provided that the said element is a polymeric material that has ionic type fillers.

More specifically, for example, it is possible to choose:

a poly(ammonium) of formula:

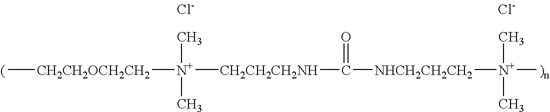

a poly(ammonium styrene sulfonic acid) with the formula:

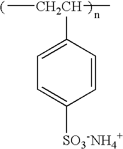

a poly(styrene sulfonate)with the formula:

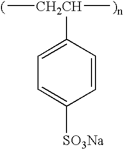

a saponified acrylic acid with the formula:

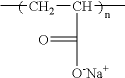

It is also possible to choose one of the polymers mentioned above in which the size of the cation has been changed to obtain a frequency more adapted to the frequency of the oscillations to be damped.

If the dielectric loss is obtained at the frequency desired through interfacial polarisation relaxation (or Maxwell-Wagner relaxation), it can also be provided that the said element is constituted by an insulating polymer matrix containing inclusions (fillers) from a conductive material. These same conductive inclusions may themselves be either a mineral filler (carbon black, carbonyl iron), or a polymeric material dispersed in the insulating polymer matrix.

More specifically, for example, the following can be chosen for the insulating matrix:

the PVAc of formula:

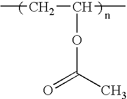

The P(Vac-co- CROTONIC ACID) of formula:

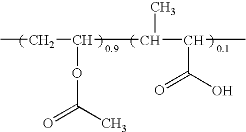

For example, the following types of conductive polymers can be chosen for the conductive material:

a PAni salt:

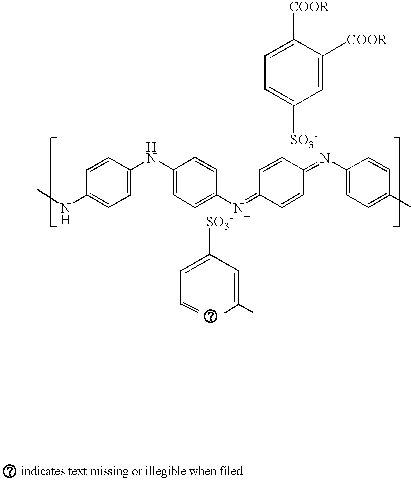

a polypyrrole:

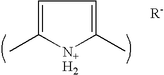

The size of the conductive material fillers will be adapted to the frequency of the oscillations to be absorbed.

The area of a winding in which such an element is realised may be situated, for example, in the CO common part of the windings, such as the element EL1 in FIG. 5a. The element is, for example, realised on the face of the CO common part which is opposite the face of the common part to be affixed to the cathode ray tube. According to the embodiment in FIG. 5b, the EL2 element covers almost the entire face of the CO common part of the windings.

According to the embodiment in FIG. 5c, the EL3 element covers several faces of the CO common part, or even covers all the faces of this common part.

According to another embodiment, the EL4 element is realised on a specified area of a particular winding such as b4 (refer to FIG. 5d). In this case, the element can, as in FIG. 5c, cover several faces of the b4 winding.

According to another variant not shown, the material of the element deposited on a winding to absorb the oscillation phenomena can be designed to go between the different winding wires. In particular, it can infiltrate between the wires.

In the different embodiments above, the elements made of material with strong dielectric losses in the resonance frequency range to be absorbed are placed in the areas where the existence of spurious capacitances have been identified between certain turns of the winding. These elements result in the introduction of a damping resistance RA in parallel with these spurious capacitances. An electrical diagram is obtained as illustrated in FIG. 6.

The search for areas showing spurious capacitances can be carried out in the following manner.

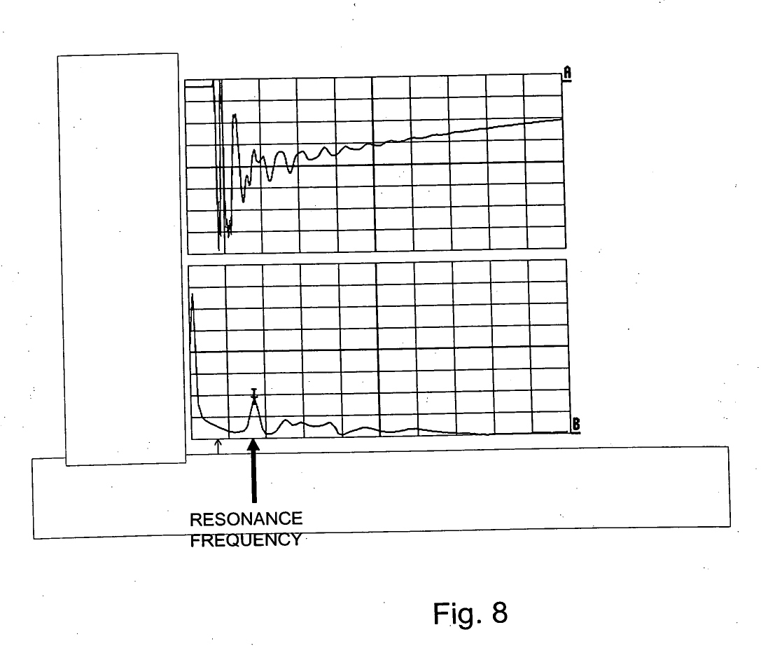

An electromagnetic probe used to measure the electric field is placed within the coil, preferably in accordance with the ZZ′ axis of the coil (refer to FIG. 4). A generator of rectangular (or square) signals is connected to the terminals of the coil. The voltage at the terminal of the wave is then measured (see FIG. 7). A temporal signal is thus displayed in the oscilloscope that corresponds to the upper curve in FIG. 8 and a lower curve which represents the Fourier transform of the previous curve. On these curves it is possible to detect a peak characterizing a resonance frequency for the coil. A material susceptible to absorb the oscillation represented by the resonance signal is then placed successively in different areas of the coil. When this material is placed in an area of the coil in which a spurious capacitance exists between wires of the coil participating in the oscillation, the resonance peak disappears on the oscilloscope and it is known that an element (EL1 to EL4) as described above must be deposited in this area.

The invention thus allows the absorption of internal oscillation phenomena within the coil by implementing a coating which, through dielectric loss, absorbs the energy of the disturbance oscillation. The invention thus does not use additional electrical components (RC circuits, etc.) between, for example, the coil and its power-supply circuit or, another example, between certain turns on a single coil.

The invention thus does not require:

any additional component on the deflector (damping circuit),

any additional output on the midpoint of the coil. (required for the implementation of certain damping circuits),

any modification of the shapes of the coil and thus conserves the electron optics performances of the deflector,

any modification of the winding wires and thus any modification of the procedure for realizing the wiring or any procedure for manufacturing the windings.

The invention thus provides an economical solution to the problem of the ringing of coils. In addition, the damping of nuisance frequencies is obtained without disturbing useful frequencies and, particularly in the case of a cathode ray tube, without disturbing the return line frequency.

1. Multiwinding coil intended to act as a deflection coil for a cathode ray tube, comprisING on and/or between the winding wires, an element made of a polymeric material or a mixture of polymers located in a delimited area of the coil.

2. Coil according to claim 1, wherein the said element is situated on at least one face of the coil in the said delimited area.

3. Coil according to claim 1, wherein the said area is situated on a section common to the various windings of the said coil.

4. Coil according to claim 3, wherein the said element is situated on one face of the common section of the coil, the said face is opposite the face designed to be in contact with a cathode ray tube.

5. Coil according to claim 1, wherein the material of the said element coats all or part of the turns or groups of turns of the coil in the said delimited area.

6. Coil according to claim 1, wherein the material of the said element is a polymeric material which has ionic type fillers.

7. Coil according to claim 1, wherein the material of the said element constitutes an insulating polymer matrix that contains conductive polymeric material fillers.

8. Coil according to claim 6, wherein the material of the said element comprises an insulating polymeric matrix of formula:
the PVAc of formula: 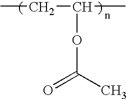
or the P(Vac-co- CROTONIC ACID) of formula: 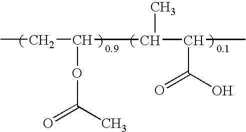
and wherein the conductive material fillers are a polymer of formula:

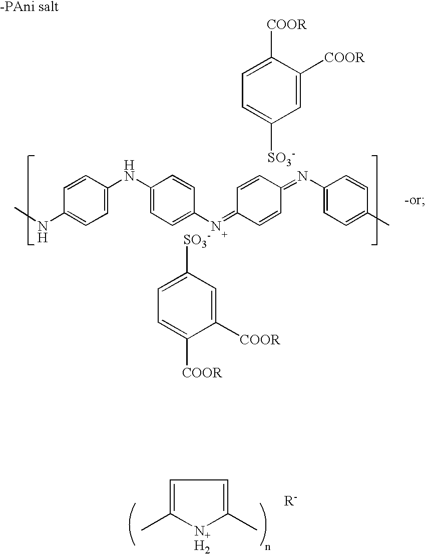

9. Coil according to claim 1, wherein the material of the said element is a polymer of formula:
a poly(ammonium) of formula: 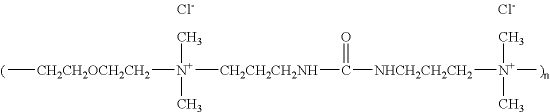
or a poly(ammonium styrene sulfonic acid) of formula: 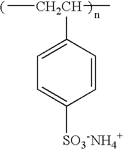
or a poly(styrene sulfonate) of formula: 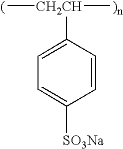
or a saponified acrylic acid of formula:

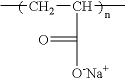

10. Coil according to claim 1, wherein the material of the said element is a polymer of the dielectric polymer family either by ionic polarisation relaxation, or by interfacial polarisation relaxation.

11. Coil according to claim 1, wherein the material of the said element can absorb electromagnetic resonance phenomena in a range of frequencies in the range from 1 to 6 MHz and in that the usage frequency is in the range from 100 to 300 kHz.
